(19) United States
(12) Patent Application Publication
(10) Pub. No.: US 2007/0072129 A1
(43) Pub. Date: Mar. 29, 2007

(54) METHOD FOR FORMING FLEXIBLE PRINTED CIRCUIT BOARDS

(75) Inventors: CHIA-CHUN LIAO, Tayuan, Taoyuan (TW); POR-YANN JIANG, Tayuan, Taoyuan (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN ADVANCED TECHNOLOGY INC., Tayuan (TW)

(21) Appl. No.: 11/309,363

(22) Filed: Aug. 1, 2006

(30) Foreign Application Priority Data
Sep. 21, 2005 (CN) 200510037466.X

(51) Int. Cl. G03C 5/00

(52) U.S. Cl. 430/311

(57) ABSTRACT

The present invention provides a method for forming flexible printed circuit boards. The method includes the following steps: providing a substrate with a copper film formed on at least one surface of the substrate; and forming a number of copper holes in the copper film through a photolithography process. The photolithography process includes a step of coating a liquid photoresist onto the copper film.

### FIELD OF THE INVENTION

The present invention relates to methods for manufacturing flexible printed circuit boards and, more particularly, to a method for manufacturing via holes in the flexible printed circuit boards.

### DESCRIPTION OF RELATED ART

With the development of science and technology, microphones, portable computer and electronic products used in cars etc. require ever greater levels of miniaturization and lightness. To meet these requirements, the degree of circuit integration is increasing, circuit pattern achieved is becoming ever more dense; and width of traces, gaps between traces and diameter of via holes are becoming ever more fine. To accommodate these developments in the art, flexible printed circuit boards have been developed.

Typical flexible printed circuit boards include base films, and copper films disposed on two opposite surfaces of the base films. Conductive traces are disposed in the copper films. Via holes pass through at least one copper film and base film functioning to conduct the conductive traces. The via holes are comprised of copper holes in the copper films, and film holes in the base films.

A typical method for forming the flexible printed circuit boards is by an etching process with a dry film photoresist. As an example, in forming copper holes, the etching process generally includes the steps of: firstly, providing a copper coated substrate, which includes a base film and a copper film coated onto one surface of the base film. Secondly, pressing a dry film photoresist onto the copper film and exposing with a plastic photomask which has a desired pattern. After exposure, part of dry film photoresist can be dissolved, while residual insoluble portions of the dry film photoresist form desired patterns. Thirdly, developing with a developing agent to remove the soluble portions of the dry film photoresist, while the residual portions covering the copper films can protect the copper films from corrosion. Therefore the desired pattern is formed, and the undesired parts of the copper film are left uncovered. Finally, etching the undesired parts of the copper film to obtain a number of copper holes. Therefore, parts of the base film corresponding to the copper holes are exposed. The residual dry film is then removed and the exposed portions of the base film are then etched to form film holes in the base film.

A photo-lithography process for forming traces on the copper coated substrate is similar to the process for forming the copper holes. The difference is that another patterned photo mask is used to form the traces instead of the former one.

The typical method for forming the flexible printed circuit boards described above has the following disadvantages. First of all, dry film is introduced into the photolithography process, which are pressed entirely onto the copper film. During pressing, bubbles may occur, which leads to low adhesion between the dry film and the copper film. Secondly, dry film is overly thick and has poor adhesion, which may adversely effect the formation of fine traces and holes. Thirdly, plastic photo masks are prone to distortion under exposure, therefore, sizes of image patterns formed thereby may not meet the requirements, thus affecting the final products.

Therefore, a heretofore-unaddressed need exists in the industry to address the aforementioned deficiencies and inadequacies.

### SUMMARY OF THE INVENTION

In a preferred embodiment, a method for forming flexible printed circuit boards includes the following steps: providing a substrate with a copper film formed on at least one surface of the substrate; and forming a number of copper holes in the copper film through a photolithography process. The photolithography process includes a step of coating a liquid photoresist onto the copper film.

### BRIEF DESCRIPTION OF THE DRAWINGS

Many aspects of the present method can be better understood with reference to the following drawings. The components in the drawings are not necessarily drawn to scale, emphasis instead being placed upon clearly illustrating the principles of the present method. Moreover, in the drawings, like reference numerals designate corresponding parts throughout the several views.

FIG. 1 is a flow chart of a preferred method for forming flexible printed circuit boards (abbreviated as FPCB); and

FIGS. 2A˜2J are schematic views of the preferred method for forming FPCB as shown in FIG. 1.

### DETAILED DESCRIPTION OF THE INVENTION

The flexible printed circuit board is made from a substrate with at least one surface thereof coated with copper film, via holes and traces are formed on the substrate. The via holes are comprised of copper holes formed in the copper films and film holes formed in the substrate. A material of the substrate is one of the following groups: polyimide, polyester, teflon, polymethyl methacrylate and polycarbon etc.

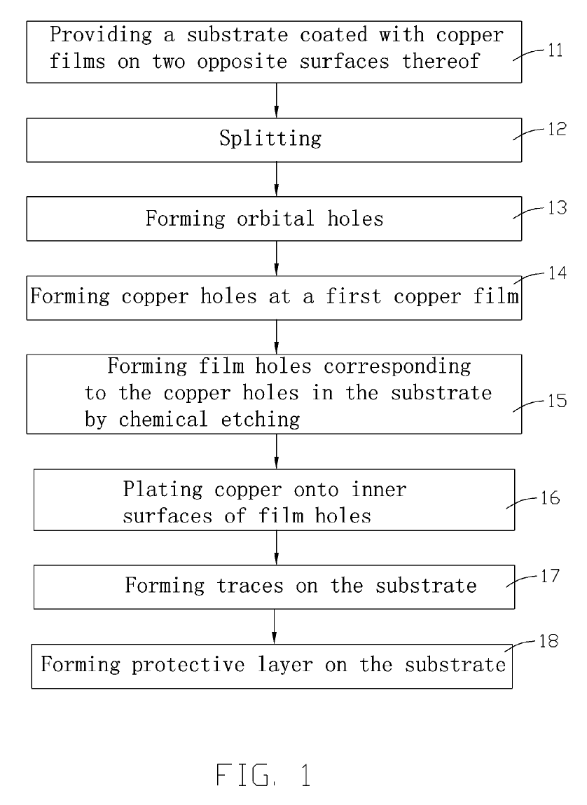

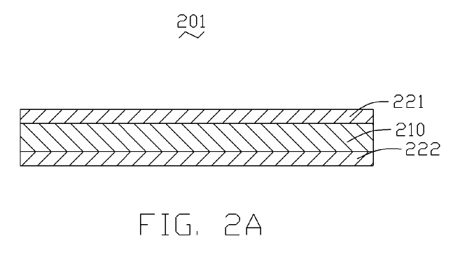

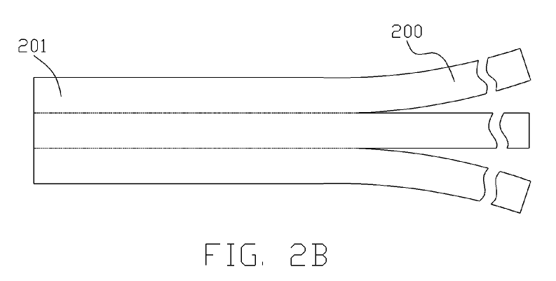

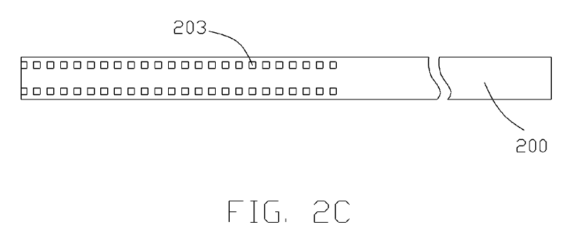

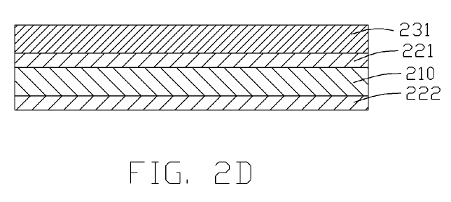

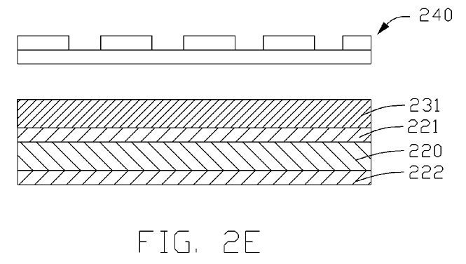

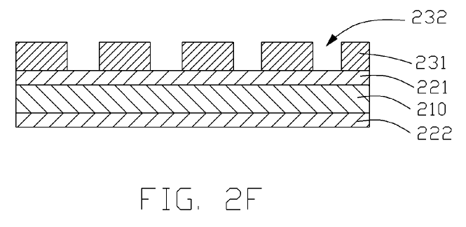

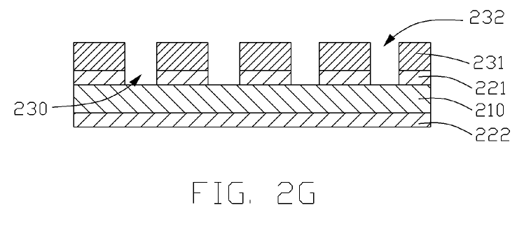

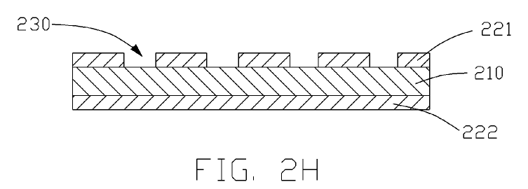

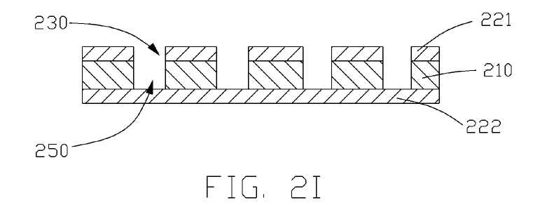

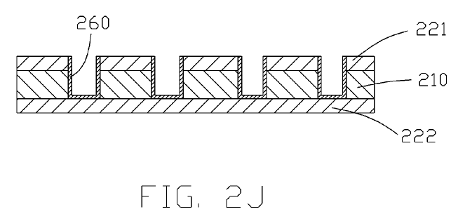

Referring to FIGS. 1 and 2A˜2J, a method for forming flexible printed circuit boards comprises the following steps:

Step 11: referring to FIG. 2A, a copper coated substrate 201 is provided, which includes a substrate 210, a first copper film 221 and a second copper film 222 disposed on two opposite surfaces of the substrate 210. The first copper film 221 and the second copper film 222 are formed by a sputtering method.

Step 12: referring to FIG. 2B, the copper coated substrate 201 is split into a number of parallel strips 200. Each strip 200 includes a substrate layer 210, a first copper film layer 221 and a second copper film layer 222 formed thereon.

Step 13: referring to FIG. 2C, orbital holes 203 are formed along two sides of each strip 200.

Step 14: referring to FIGS. 2D˜2H, a photolithography process is performed to form copper holes 230 in the first copper film layer 221. The lithography process includes the following steps: first of all, cleaning the surface of the first copper film layer 221. Secondly, referring to FIG. 2D, spraying a liquid photoresist onto the first copper film layer 221 to form a liquid photoresist layer 231. A material of the liquid photoresist layer 231 also may be a positive photoresist or a negative photoresist material. In the embodiment, the liquid photoresist is a positive photoresist. Thirdly, exposing with a photo mask 240, referring to FIG. 2E, the photo mask 240 has a desired pattern. The material of the photo mask 240 is glass. After exposure, exposed portions of the positive photoresist layer 231 undergo chain scission therefore becoming soluble. If the liquid photoresist layer 231 is comprised of a negative photoresist material, after exposure, exposed portions of negative photoresist will experience cross-linking reaction therefore becoming insoluble. Fourthly, referring to FIG. 2F, developing with a developing agent to remove soluble portions of the photoresist, residual insoluble portions can protect the copper film 221 from corrosion when etched. The desired patterns 232 are thus formed. Fifthly, etching the uncovered parts of the copper film 221 to form a plurality of copper holes 230. From FIG. 2G it can be seen that, in this way, parts of the substrate 210 corresponding to the copper holes 230 are left uncovered. Finally, removing the residual liquid photoresist layer 231 as shown in FIG. 2H.

The liquid photoresist layer 231 includes resin, sensitizer and solvent. Resin therein can provide adhesion between the sensitizer and the copper film 221 and also can give the liquid photoresist layer 231 greater corrosion resistance. Sensitizer is sensitive to a certain light, that is, the sensitizer undergoes photochemical reaction induced by light. The solvent is flowable, and thus allows the liquid photoresist layer 231 to form on the first copper film layer 221 uniformly. Furthermore, the thickness of the photoresist layer 231 is more controllable when the photoresist is liquid. The thickness of the photoresist layer 231 may be several times of a wavelength of the certain light, that is, several hundreds or several thousands of nanometers.

Step 15: referring to FIG. 21, etching the uncovered parts of the substrate 210 to form film holes 250 therein. Each film hole 250 is aligned with a copper hole 230. The film holes 250 allow the exposure of the second copper film 222. The etching reagent thereof is an ethanolamine alkaline solution.

Step 16: referring to FIG. 2J, plating a copper layer 260 onto inner circumferential surfaces of the film holes 250 and the copper holes 230. Copper can also be only plated onto inner circumferential surfaces of the film holes 250. Copper functions to electronically connect the traces on two opposite surfaces of the substrate 210. This step is carried out by following steps: cleaning the inner circumferential surfaces of the holes and making the inner circumferential surfaces of the holes positive; adhering a layer of carbon powder onto the inner circumferential surfaces of the holes, which is negative; and plating copper onto the carbon powder layer to finish plating step.

Step 17: a photo-lithography process of forming traces on the substrate 210 follows thereafter, similar to the steps as shown in FIGS. 2E˜2H. The difference is that another photo mask with patterns needed to form the traces is used instead of the former one. The photo mask used is also made of glass.

Steps 11 to step 17 may be repeated to form holes and traces on the second copper film 222 in case both sides require traces and holes.

Step 18: a protective layer may be printed on the substrate 210 with holes and traces formed thereon, which can protect the holes and traces from pollution and oxidation. A gilding process, a cutting process and an electronic inspection may follow thereafter, thus forming a flexible printed circuit board.

Compared with conventional methods, as liquid photoresist is used in the method of the preferred embodiment, it can be uniformly sprayed onto the copper film anywhere, especially the places around the orbital holes. During photolithography and etching processes, copper film and substrate around the orbital holes will not be etched, therefore, rigidity of the orbital holes is enhanced. Furthermore, compared with the dry film, the liquid photoresist can firmly adhere with the copper film, and no bubbles occur.

The method of the preferred embodiment uses a photo mask made of glass instead of plastic, since glass can be uniformly heated and has lower dilatability, furthermore, glass has better light transmission properties, which can make the quality of product more stable.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for forming flexible printed circuit boards, comprising the following steps:
providing a substrate with a copper film formed on at least one surface of the substrate; and
forming a plurality of copper holes in the copper film through a photolithography process, wherein the photolithography process comprises a step of coating a liquid photoresist onto the copper film.

2. The method for forming flexible printed circuit boards as claimed in claim 1, wherein the liquid photoresist is comprised of either a positive photoresist material or a negative photoresist material.

3. The method for forming flexible printed circuit boards as claimed in claim 1, wherein the photolithography process further comprises the following steps after coating the liquid photoresist: exposing, developing, etching and removing the liquid photoresist.

4. The method for forming flexible printed circuit boards as claimed in claim 3, wherein during the exposure step, photo masks made of glass are employed.

5. The method for forming flexible printed circuit boards as claimed in claim 1, further comprising a step of forming film holes in the substrate, wherein each film hole is aligned with a corresponding copper hole.

6. The method for forming flexible printed circuit boards as claimed in claim 5, wherein the film holes are formed by a method of etching the substrate corresponding to the copper holes with chemical etching reagent.

7. The method for forming flexible printed circuit boards as claimed in claim 6, wherein the chemical etching reagent is an ethanolamine alkaline solution.

8. The method for forming flexible printed circuit boards as claimed in claim 5, further comprising a step of plating copper onto circumferential surfaces of the film holes after forming the film holes.

9. The method for forming flexible printed circuit boards as claimed in claim 8, further comprising a step of forming copper traces onto the copper film after the copper plating step.

10. The method for forming flexible printed circuit boards as claimed in claim 9, wherein the traces are formed by a photolithography process.

11. The method for forming flexible printed circuit boards as claimed in claim 10, further comprising a step of applying a protective layer onto the substrate after forming the traces.

12. The method for forming flexible printed circuit boards as claimed in claim 1, further comprising a step of forming orbital holes along two sides of the substrate before forming the copper holes.

13. A method for forming flexible printed circuit boards, comprising the following steps:
providing a substrate with a copper film formed on at least one surface of the substrate;
forming a plurality of copper holes in the copper film by a photolithography process, forming a plurality of film holes in the substrate by etching the portions of the substrate corresponding to the copper holes, each film hole being aligned with a corresponding copper hole;
plating copper onto circumferential surfaces of the film holes; and
forming copper traces onto the copper film by a photolithography process;
wherein each of the photolithography processes comprises a step of applying a liquid photoresist onto the copper film.
